(19) United States
(12) Patent Application Publication
(10) Pub. No.: US 2024/0094031 A1
(43) Pub. Date: Mar. 21, 2024

(54) POSITION DETECTION DEVICE AND VEHICLE STEERING DEVICE

(71) Applicant: Proterial, Ltd., Tokyo (JP)

(72) Inventors: Yohei SHIRAKAWA, Tokyo (JP); Yoshiaki YANAGISAWA, Tokyo (JP)

(21) Appl. No.: 18/464,812

(22) Filed: Sep. 11, 2023

(30) Foreign Application Priority Data
Sep. 20, 2022 (JP) 2022-149548
Aug. 9, 2023 (JP) 2023-129986

(51) Int. Cl. G01D 5/20; B62D 5/04; B62D 15/02

(52) U.S. Cl. CPC G01D 5/2053; B62D 5/0421; B62D 15/0215

(57) ABSTRACT

A position detecting device is configured to detect a position of a moving member in which a conductive portion and a non-conductive portion having greater electrical resistance than the conductive portion are provided side by side in a predetermined moving direction. The position detection device is provided with an exciting coil and a detection coil that are arranged extending in the moving direction of the moving member. A voltage is induced in the detection coil by a current flowing in the conductive portion due to a magnetic field generated by the exciting coil. A magnitude of the voltage induced in the detection coil varies with a position in the moving direction of the moving member relative to the detection coil. A vehicle steering device is provided with a shaft, a housing, and the position detecting device.

### CROSS-REFERENCE TO RELATED APPLICATIONS

The present application is based on Japanese patent application No. 2022-149548 filed on Sep. 20, 2022, and Japanese patent application No. 2023-129986 filed on Aug. 9, 2023, the entire contents of which are incorporated herein by reference.

### TECHNICAL FIELD

The present invention relates to a position detection device for detecting the position of a moving member and a vehicle steering device equipped with the position detection device.

### BACKGROUND OF THE INVENTION

Conventional position detection devices for detecting the position of moving members are used, for example, in movable parts of automobiles. The applicant has proposed the stroke sensor described in Patent Literature 1 as such a position detection device.

The stroke sensor described in Patent Literature 1 comprises a magnetic field detecting part such as a Hall IC, two parallel yokes sandwiching the magnetic field detecting part in a stroke direction of a stroke body, a magnetic path forming yoke extending in the stroke direction of the stroke body with a predetermined distance between the two parallel yokes, a magnet disposed between one ends of the respective two parallel yokes and the magnetic path forming yoke, a magnet disposed between one end of each of the two parallel yokes and the magnetic path forming yoke, a parallel magnetic field forming yoke movably disposed between the two parallel yokes and the magnetic path forming yoke and facing the two parallel yokes, and a projection yoke integrally provided on the side of the magnetic path forming yoke in the parallel magnetic field forming yoke. This stroke sensor can detect the position of the parallel magnetic field forming yoke by the intensity of the magnetic field detected in the magnetic field detection part, since the intensity of the magnetic field changes according to the position of the parallel magnetic field forming yoke.
Citation List Patent Literature 1: JP2014-98655A

### SUMMARY OF THE INVENTION

In the stroke sensor described in Patent Literature 1, the two parallel yokes and the magnetic path forming yoke must be arranged to sandwich the parallel magnetic field forming yoke and the projection yoke over the entire movement range of the parallel magnetic field forming yoke, resulting in a large installation size of the stroke sensor. Therefore, an object of the present invention is to provide a position detection device that can be downsized and a vehicle steering device equipped with the position detection device.

For the purpose of solving the above problem, one aspect of the present invention provides a position detecting device configured to detect a position of a moving member in which a conductive portion and a non-conductive portion having greater electrical resistance than the conductive portion are provided side by side in a predetermined moving direction, comprising:
an exciting coil and a detection coil that are arranged extending in the moving direction of the moving member,
wherein a voltage is induced in the detection coil by a current flowing in the conductive portion due to a magnetic field generated by the exciting coil, and wherein a magnitude of the voltage induced in the detection coil varies with a position in the moving direction of the moving member relative to the detection coil.

Further, for the purpose of solving the above problem, another aspect of the present invention provides vehicle steering device, comprising:
a shaft comprising a conductive metal that moves axially forward and backward along a vehicle width direction;
a housing comprising a conductive metal that houses the shaft; and
a position detecting device that detects a position of the shaft relative to the housing,
wherein a wheel is steered by axial movement of the shaft,
wherein the shaft is provided with a recessed portion formed in a radial direction,
wherein the position detection device comprises an exciting coil and a detection coil that are arranged extending in the vehicle width direction on the shaft,
wherein a voltage is induced in the detection coil by a current flowing in the shaft due to a magnetic field generated by the exciting coil, and
wherein a magnitude of the voltage induced in the detection coil varies in accordance with a position of the shaft relative to the housing.

### Advantageous Effects of the Invention

According to the present invention, the position detection device can be downsized. In addition, the miniaturization of the position detection device improves the ease of installation of the vehicle steering device in a vehicle.

### BRIEF DESCRIPTION OF DRAWINGS

FIG. 1A is a schematic diagram of a portion of a vehicle equipped with a vehicle steering device according to an embodiment of the present invention.

FIG. 1B is an A-A cross-sectional view of FIG. 1A.

FIG. 2 is a perspective view showing a rack shaft, a housing, a lid member, and a substrate.

FIG. 3A is an overall view of wiring patterns formed in the first to fourth metal layers of the substrate, viewed from a surface side in perspective.

FIG. 3B is an enlarged partial view of FIG. 3A.

FIGS. 4A to 4D are plan views showing the first to fourth metal layers viewed from the surface side, respectively.

FIG. 5 is a graph showing an example of the relationship between the supply voltage supplied from a power supply unit to an exciting coil and the induced voltage induced in a sine wave-shaped detection coil and a cosine wave-shaped detection coil.

FIG. 6A is an explanatory diagram of the relationship between the peak voltage, which is the peak value of the induced voltage induced in the sine wave-shaped detection coil, and the position of a recessed portion.

FIG. 6B is an explanatory diagram of the relationship between the peak voltage, which is the peak value of the induced voltage induced in the cosine wave-shaped detection coil, and the position of the recessed portion.

FIG. 7A is a graph showing the moving amount of the rack shaft from the reference position on the horizontal axis and the detection error rate in the moving amount of the rack shaft on the vertical axis.

FIG. 8A is a cross-sectional view showing a configuration example when the stroke sensor according to the embodiment detects the position of a rack shaft in a comparative example, to which a conductive metal member as a detection target is attached, relative to a housing.

FIG. 8B is a perspective view showing the rack shaft, the detection target, and the housing in the comparative example.

FIG. 9 is a graph showing the detection error of the moving amount of the rack shaft in the comparative example.

### DETAILED DESCRIPTION OF THE INVENTION

### Embodiment

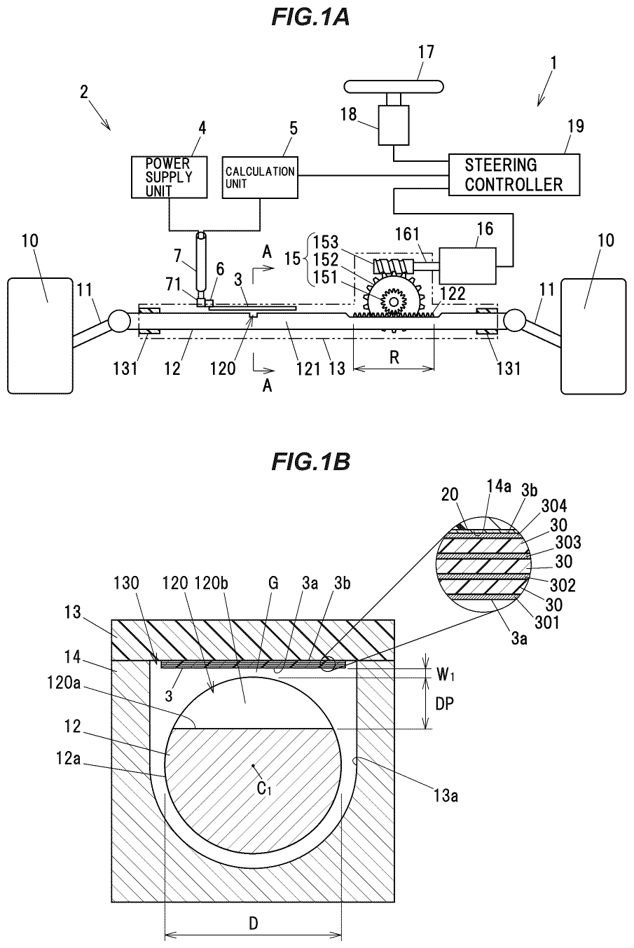

FIG. 1A is a schematic diagram of a portion of a vehicle equipped with a vehicle steering device 1 according to an embodiment of the present invention. FIG. 1B is an A-A cross-sectional view of FIG. 1A.

This vehicle steering device 1 is a steer-by-wire steering device including a stroke sensor 2 as a position detection device. In FIG. 1A, the vehicle steering device 1 is viewed from the rear side in a vehicle front-rear direction, the right side of the drawing corresponds to the right side in a vehicle width direction, and the left side of the drawing corresponds to the left side in the vehicle width direction. The terms “right” and “left” are sometimes used in the following description with reference to the drawings, but this expression is used for convenience of explanation and does not limit the direction of arrangement when the stroke sensor 2 is actually in use.

As shown in FIG. 1A, the vehicle steering device 1 includes tie rods 11 connected to steered wheels 10 (left and right front wheels), a rack shaft 12 connected to the tie rods 11, a housing 13 that houses the rack shaft 12, a lid member 14 closing an opening of the housing 13 (see FIG. 1B), a worm speed reduction mechanism 15 having a pinion gear 151 meshed with rack teeth 122 of the rack shaft 12, an electric motor 16 that applies a moving force in a vehicle width direction to the rack shaft 12 through the worm speed reduction mechanism 15, a steering wheel 17 operated by a driver, a steering angle sensor 18 to detect a steering angle of the steering wheel 17, and a steering controller 19 that controls the electric motor 16 based on the steering angle detected by the steering angle sensor 18.

The rack shaft 12 is a moving member whose position relative to the housing 13 is detected by the stroke sensor 2. A moving direction of the rack shaft 12 is an axial direction parallel to a central axis C1 of the rack shaft 12. The steered wheels 10 are steered by the movement in the axial direction of the rack shaft 12.

In FIG. 1A, the housing 13 is indicated by a phantom line, and an inside of the housing 13 is indicated by a solid line. The rack shaft 12 is made of, e.g., steel such as carbon steel and is supported by a pair of rack bushings 131 attached to both ends of the housing 13. The worm speed reduction mechanism 15 has a worm wheel 152 and a worm gear 153, and the pinion gear 151 is fixed to the worm wheel 152. The worm gear 153 is fixed to a motor shaft 161 of the electric motor 16.

The electric motor 16 generates torque by a motor current supplied from the steering controller 19 and rotates the worm wheel 152 and the pinion gear 151 through the worm gear 153. When the pinion gear 151 rotates, the rack shaft 12 linearly moves back and forth along the vehicle width direction. The rack shaft 12 can move to the right and left in the vehicle width direction within a predetermined range from a neutral position at which the steering angle is zero.

In FIG. 1A, a double-headed arrow indicates a stroke range R that corresponds to the maximum travel distance of the rack shaft 12 when the steering wheel 17 is operated from one of the left and right maximum steering angles to the other maximum steering angle. The stroke sensor 2 can detect the absolute position of the rack shaft 12 relative to the housing 13 over the entire stroke range R.

(Configuration of Stroke Sensor 2)

The stroke sensor 2 includes a substrate 3 arranged so as to face the rack shaft 12, a power supply unit 4, and a calculation unit 5. The stroke sensor 2 detects the position of the rack shaft 12 in the axial direction (the moving direction) relative to the housing 13 and outputs information of the detected position to the steering controller 19. The steering controller 19 controls the electric motor 16 so that the position of the rack shaft 12 detected by the stroke sensor 2 corresponds to the steering angle of the steering wheel 17 detected by the steering angle sensor 18.

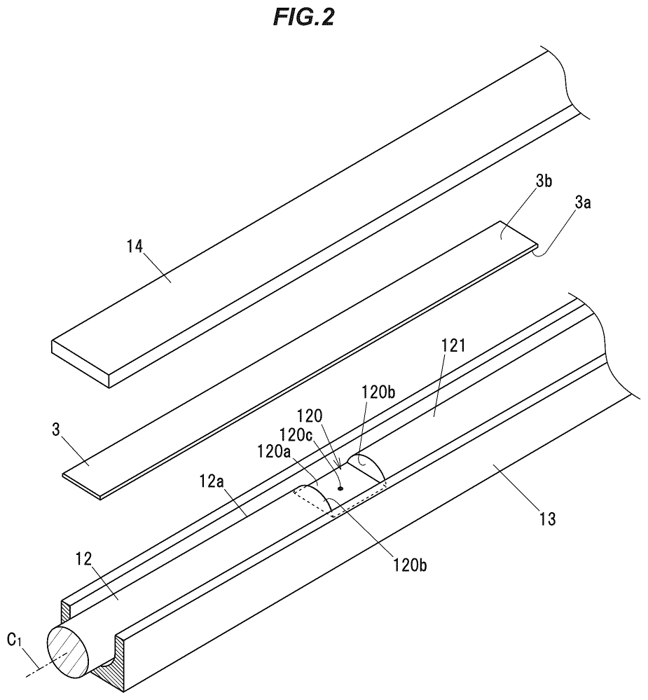

FIG. 2 is a perspective view showing the rack shaft 12, the housing 13, the lid member 14, and the substrate 3. In FIG. 2, the housing 13, the lid member 14, and the substrate 3 are shown spaced apart in the vertical direction in the drawing.

The rack shaft 12 and the housing 13 are made of conductive metal. The rack shaft 12 is carbon steel for machine structural use, such as S45C, and has a circular shape in cross-section perpendicular to the axial direction in the range facing the substrate 3, except for a recessed portion 120 described below. A diameter D of the rack shaft 12 is, e.g., 25 mm. The housing 13 is made of an aluminum alloy, for example, die-cast and molded, U-shaped in cross-section, and is open upward in the vertical direction. The opening 130 of the housing 13 is closed by the lid member 14.

A gap of, e.g., 1 mm or more is formed between an outer circumference surface 12a of the rack shaft 12 and an inner surface 13a of the housing 13. The lid member 14 is a non-conductive member formed in the shape of a flat plate. For example, a resin such as an engineering plastic can be suitably used as the material of the lid member 14.

The rack shaft 12 includes the recessed portion 120 formed in the radial direction of the rack shaft 12 in the portion facing the substrate 3. The recessed portion 120 is formed in a portion in a circumferential direction (i.e., circumferential portion) of the outer circumference surface 12a of the rack shaft 12. In this embodiment, the recessed portion 120 is a vacant space, but the recessed portion 120 may be filled with a non-conductive material such as resin, for example.

The width of the recessed portion 120 in the axial direction of the rack shaft 12 is shorter than a longitudinal length of the substrate 3. The portion of the rack shaft 12 where the recessed portion 120 is not provided is a conductive portion 121, which is electrically conductive. In other words, the rack shaft 12 has the conductive portion 121 and a non-conductive portion with greater electrical resistance than the conductive portion 121 side by side in the axial direction, and in this embodiment, the non-conductive portion is embodied by the recessed portion 120. In other words, in the present embodiment, the recessed portion 120 faces the substrate 3. The portions facing the substrate 3 in the rack shaft 12 are, along the axial direction (moving direction), the conductive portion 121, the recessed portion 120 as the non-conductive portion, and the conductive portion 121, that are aligned side by side in this order.

The recessed portion 120 is formed by notching a portion of a round bar (i.e., circular rod) as the material of the rack shaft 12, by cutting, for example. In this embodiment, a bottom surface 120a of the recessed portion 120 is a plane parallel to the substrate 3, and two end surfaces 120b, 120b of the recessed portion 120 face each other in the axial direction across the bottom surface 120a. A depth Dp of the recessed portion 120 in the radial direction of the rack shaft 12 is, e.g., 5 mm. The rack shaft 12 is regulated to rotate about a central axis C1 with respect to the housing 13 in such a manner that the bottom surface 120a always faces parallel to the substrate 3.

The substrate 3 is mounted on the lid member 14 and a front surface 3a faces a portion in the axial direction of the rack shaft 12 including the recessed portion 120 through an air gap G. A minimum width W1 of the air gap G in the direction perpendicular to the substrate 3 (the shortest distance between the front surface 3a of the substrate 3 and the outer circumference surface 12a of the rack shaft 12) is, e.g., 1 mm or less. A back surface 3b of the substrate 3 is fixed to an inner surface 14a on the rack shaft 12-side in the lid member 14 by means of an adhesive 20.

The substrate 3 is a four-layered substrate in which flat plate-shaped bases 30 made of a dielectric such as FR4 (glass fiber impregnated with epoxy resin and heat-cured) are arranged between first to fourth metal layers 301 to 304. A thickness of each base 30 is, e.g., 0.3 mm. The first to fourth metal layers 301 to 304 are made of, e.g., copper and each have a thickness of, e.g., 18 μm. The substrate 3 has a flat rectangular shape whose long side direction (longitudinal direction) coincides with the moving direction of the rack shaft 12. The substrate 3 is not limited to a rigid substrate and may be a flexible substrate.

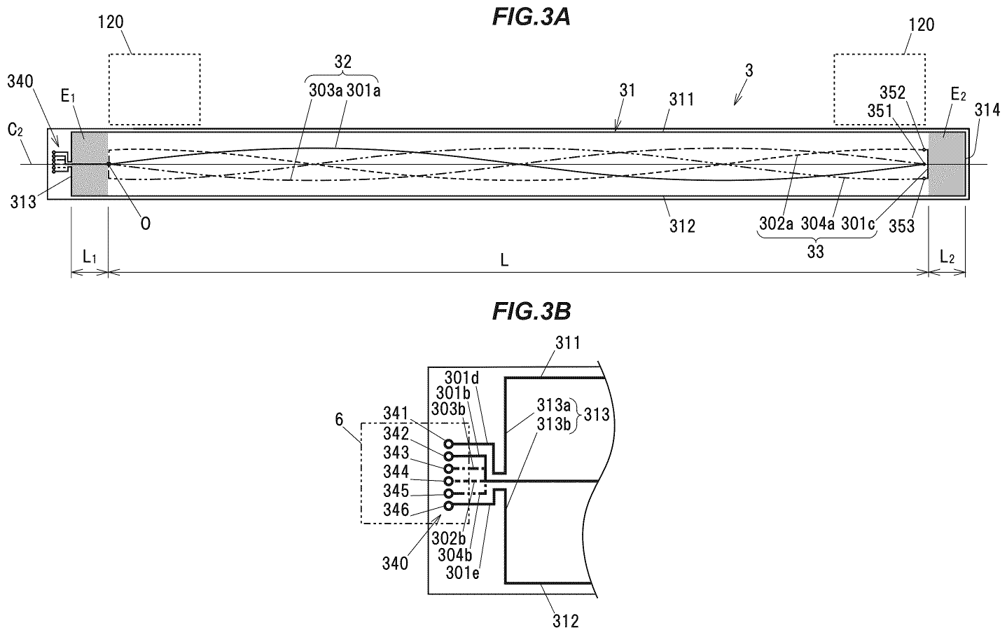

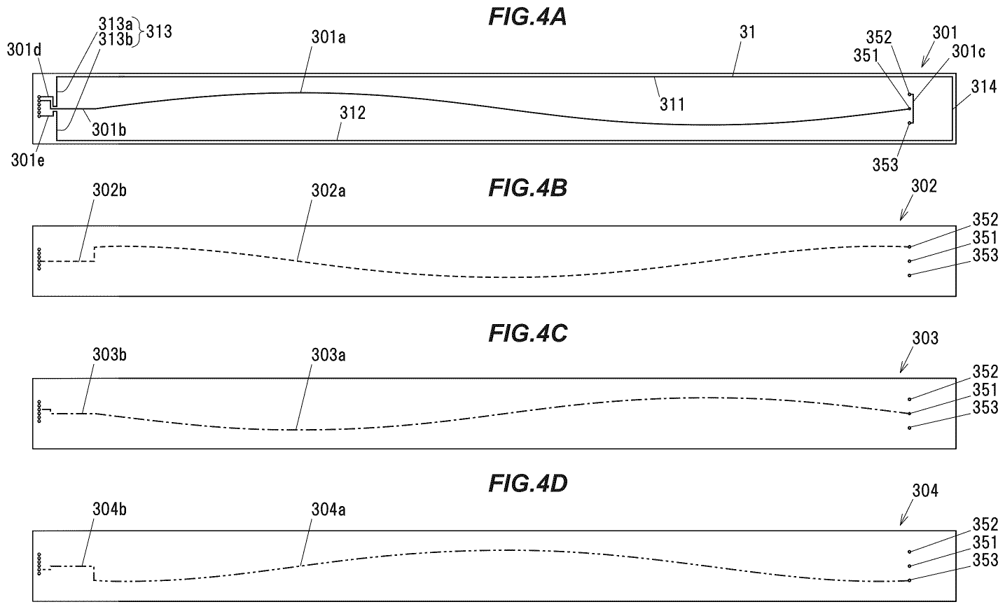

FIG. 3A is an overall view in which wiring patterns formed on first to fourth metal layers 301 to 304 of the substrate 3 are seen through from the front surface 3a-side. FIG. 3B is a partial enlarged view of FIG. 3A. FIGS. 4A to 4D are plan views respectively showing the first to fourth metal layers 301 to 304 as viewed from the front surface 3a-side. The wiring patterns shown in FIGS. 3A, 3B and 4A to 4D are merely examples, and various forms of wiring patterns can be employed as long as the substrate 3 is formed so that the effects of the invention can be obtained.

In FIGS. 3A, 3B and 4A to 4D, the wiring pattern of the first metal layer 301 is indicated by solid lines, the wiring pattern of the second metal layer 302 is indicated by dashed lines, the wiring pattern of the third metal layer 303 is indicated by dashed-dotted lines, and the wiring pattern of the fourth metal layer 304 is indicated by dashed-double-dotted lines. In FIG. 3A, a central axis C2 that bisects the substrate 3 in the short direction and extends in the longitudinal direction is shown, and the position of the recessed portion 120 when the rack shaft 12 is located at one end and the other end of the range where the stroke sensor 2 can detect the absolute position of the rack shaft 12 is shown by dotted lines. As shown in FIG. 1B, the substrate 3 and the recessed portion 120 overlap in the diameter direction of the rack shaft 12, but in FIG. 3A, the position of the recessed portion 120 is shown shifted in its lateral direction (short side direction) relative to the substrate 3.

A connector portion 340, which has first to sixth through-holes 341 to 346 into which connector pins of a connector 6 indicated by a dashed-double-dotted line in FIG. 3B are respectively inserted, is provided at one longitudinal end portion of the substrate 3. The first to sixth through-holes 341 to 346 are aligned in a straight line along a lateral direction of the substrate 3. A connector 71 (see FIG. 1A) of a cable 7 for connection to the power supply unit 4 and the calculation unit 5 is connected to the connector 6. First to third vias 351 to 353 for inter-layer connection of the wiring patterns are also formed on the substrate 3.

The first metal layer 301 has a first curved portion 301a, a first connector connection portion 301b that connects one end of the first curved portion 301a to the second through-hole 342, and an end connection portion 301c that connects the respective ends of a second curved portion 302a and a fourth curved portion 304a, which will be described later. The second metal layer 302 has a second curved portion 302a and a second connector connection portion 302b that connects one end of the second curved portion 302a to the fourth through-hole 344. The third metal layer 303 has a third curved portion 303a and a third connector connection portion 303b that connects one end of the third curved portion 303a to the third through-hole 343. The fourth metal layer 304 has a fourth curved portion 304a and a fourth connector connection portion 304b that connects one end of the fourth curved portion 304a to the fifth through-hole 345.

The first curved portion 301a and the third curved portion 303a are connected at their other ends by a first via 351. The end connection portion 301c has one end connected to the other end of the second curved portion 302a by a second via 352 and the other end connected to the other end of the fourth curved portion 304a by a third via 353.

The first to fourth curved portions 301a, 302a, 303a, 304a are sinusoidally curved (i.e., curved in sine waveform) conductor wires. The first curved portion 301a and the third curved portion 303a, and the second curved portion 302a and the fourth curved portion 304a are symmetrical about a central axis C2 of the substrate 3 as the axis of symmetry.

The substrate 3 has an exciting coil 31 that generates a magnetic flux in the conductive portion 121 of the rack shaft 12 and two detection coils 32, 33 in which the magnetic flux generated in the conductive portion 121 is chained. The exciting coil 31 and the two detection coils 32, 33 are arranged extending in the axial direction of the rack shaft 12. Of the two detection coils 32, 33, one detection coil 32 is formed by the first curved portion 301a and the third curved portion 303a. The other detection coil 33 is formed by the second curved portion 302a, the fourth curved portion 304a, and the end connection portion 301c. In other words, each of the two detection coils 32 and 33 is a combination of two sinusoidal conductor wires whose shape, viewed from a direction perpendicular to the axial direction of the rack shaft 12, is symmetrical across the central axis C2.

The exciting coil 31 is rectangular in shape having a pair of long side portions 311, 312 extending in the axial direction of the rack shaft 12 and a pair of short side portions 313, 314 between the pair of long side portions 311, 312, and is formed to surround the detection coils 32, 33. In this embodiment, the long side portions 311, 312 and the short side portions 313, 314 are formed as a wiring pattern in the first metal layer 301. Of the pair of short side portions 313, 314, the short side portion 313 on the connector portion 340-side comprises two straight portions 313a, 313b that sandwich the first to fourth connector connection portions 301b, 302b, 303b, 304b, as shown in FIG. 3B, and the respective ends of the two straight portions 313a, 313b are connected to the first through-hole 341 and the sixth through-hole 346 by the connector connection portions 301d, 301e formed in the first metal layer 301.

The exciting coil 31 is not limited to the first metal layer 301, but may be formed in any of the second to fourth metal layers 302 to 304, or may be formed over multiple layers. The exciting coil may be formed separately (i.e., as a separate body) from the substrate 3.

A sinusoidal alternating current is supplied to the exciting coil 31 from the power supply unit 4. Eddy currents are generated in the conductive portion 121 of the rack shaft 12 by the magnetic flux generated by the AC current supplied to the exciting coil 31. The eddy current lowers the density of the magnetic flux chained to the two detection coils 32, 33. Therefore, the magnetic flux density in the portion of the substrate 3 facing the conductive portion 121 is lower than the magnetic flux density in the portion of the substrate facing the recessed portion 120 as the non-conductive portion. The conductive portion 121 and the recessed portion 120 are, along the axial direction (moving direction) are arranged to face the substrate 3 in such a manner that the conductive portion 121, the recessed portion 120 as the non-conductive portion, and the conductive portion 121, that are aligned side by side in this order. Therefore, the magnetic flux density in the portion of the substrate 3 facing the recessed portion 120 is greater than the magnetic flux density in the portion of the substrate facing the conductive portion 121. Thus, induced voltage is generated in the two detection coils 32 and 33 due to the magnetic flux of the conductive portion 121 chained together. The peak value of the voltage induced in the detection coils 32, 33 varies depending on the position of the recessed portion 120. The peak value of the voltage refers to the maximum value of the absolute value of the voltage within a period of one cycle of the alternating current supplied to the exciting coil 31.

The phases of the voltages induced in each of the detection coils 32, 33 during the movement of the rack shaft 12 from one end of axial movement to the other end of axial movement are different from each other. In the present embodiment, the phases of the voltages induced in the detection coils 32, 33 differ by 90°. Hereafter, one of the two detection coils 32, 33 is referred to as a sine wave-shaped detection coil 32 and the other detection coil 33 is referred to as a cosine wave-shaped detection coil 33.

The peak values of the voltages induced in the sine wave-shaped detection coil 32 and the cosine wave-shaped detection coil 33 by the magnetic flux of the conductive portion 121 of the rack shaft 12 chained together vary within a range of one cycle or less during the movement of the rack shaft 12 from one end of axial movement to the other end of axial movement. This enables the stroke sensor 2 to detect the absolute position of the rack shaft 12 over the entire stroke range R over which the rack shaft 12 can move in the axial direction.

As shown in FIG. 3A, between each of the pair of short side portions 313, 314 of the exciting coil 31 and the sine wave-shaped detection coil 32 and the cosine wave-shaped detection coil 33, first and second buffer regions E1, E2 are provided to suppress the voltage induced in the sine wave-shaped detection coil 32 and the cosine wave-shaped detection coil 33 by the magnetic flux generated due to the electric current flowing through the pair of short side portions 313, 314. In the example shown in FIG. 3A, a length L1 of the first buffer region E1 and a length L2 of the second buffer region E2 in the longitudinal direction of the substrate 3 are the same, but L1 and L2 may be different from each other.

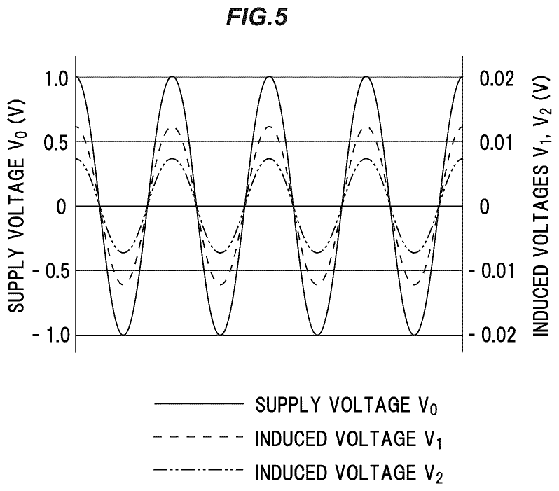

FIG. 5 is a graph showing an example of a relationship between supply voltage V0 supplied from the power supply unit 4 to the exciting coil 31, induced voltage V1 induced in the sine wave-shaped detection coil 32 and induced voltage V2 induced in the cosine wave-shaped detection coil 33. In the graph of FIG. 5, the horizontal axis is the time axis, and the left and right vertical axes indicate the supply voltage V0 and the induced voltages V1, V2. A high-frequency AC voltage of, e.g., about 1 MHz is supplied as the supply voltage V0 to the exciting coil 31. The induced voltages V1, V2 are output to the calculation unit 5 via a cable 7 as output voltages of the sine wave-shaped detection coil 32 and the cosine wave-shaped detection coil 33.

The supply voltage V0 and the induced voltages V1, V2 are in phase with each other in the example shown in FIG. 5. However, the induced voltage V1 induced in the sine wave-shaped detection coil 32 switches between in-phase and antiphase at the time that the recessed portion 120 passes through a position corresponding to an intersection point between the first curved portion 301a of the first metal layer 301 and the third curved portion 303a of the third metal layer 303 as viewed in a substrate normal direction that is perpendicular to the front surface 3a and the back surface 3b of the substrate 3. Likewise, the induced voltage V2 induced in the cosine wave-shaped detection coil 33 switches between in-phase and antiphase at the time that the recessed portion 120 passes through a position corresponding to an intersection point between the second curved portion 302a of the second metal layer 302 and the fourth curved portion 304a of the fourth metal layer 304 as viewed in the substrate normal direction.

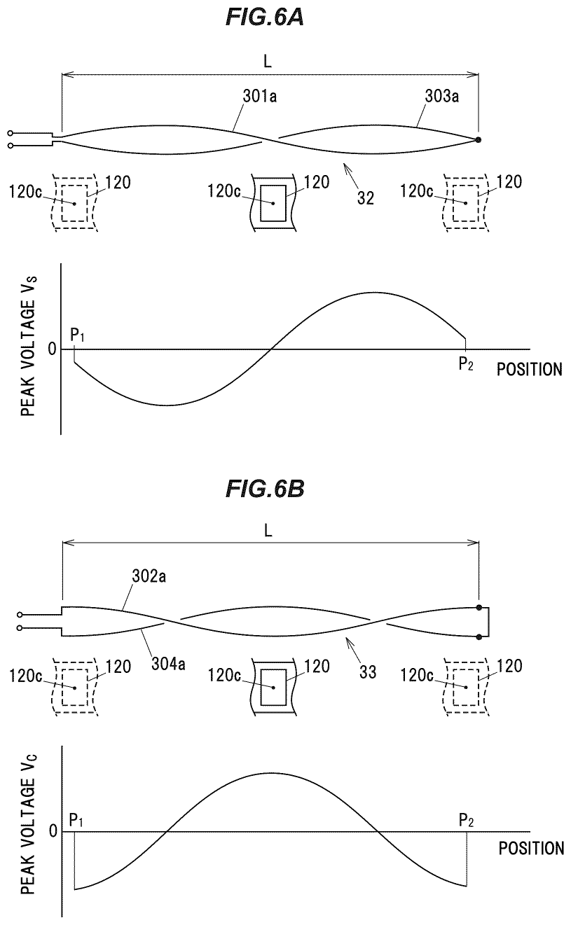

FIG. 6A is an explanatory diagram schematically illustrating a relationship between the position of the recessed portion 120 and peak voltage VS which is the peak value of the induced voltage V1 induced in the sine wave-shaped detection coil 32. FIG. 6B is an explanatory diagram schematically illustrating a relationship between the position of the recessed portion 120 and peak voltage VC which is the peak value of the induced voltage V2 induced in the cosine wave-shaped detection coil 33.

In the graphs of the peak voltages VS and VC shown in FIGS. 6A and 6B, the horizontal axis indicates the position of the center in the lateral direction of the recessed portion 120. P1 on the horizontal axis indicates the position of a center point 120c of the recessed portion 120 when the left end of the recessed portion 120 coincides with the left ends of the sine wave-shaped detection coil 32 and the cosine wave-shaped detection coil 33. P2 on the horizontal axis indicates the position of the center point 120c of the recessed portion 120 when the right end of the recessed portion 120 coincides with the right ends of the sine wave-shaped detection coil 32 and the cosine wave-shaped detection coil 33. In FIGS. 6A and 6B, the recessed portion 120 when its center point 120c is located at the position P1 is indicated by a dashed-dotted line, and the recessed portion 120 when its center point 120c is located at the position P2 is indicated by a dashed-double-dotted line. Here, the center point 120c of the recessed portion 120 is the location of the center of a bottom surface 120a, as shown in FIG. 2.

In the sine wave-shaped detection coil 32 and the cosine wave-shaped detection coil 33, the strength of the magnetic field of the portion facing the conductive portion 121 is smaller than the strength of the magnetic field of the portion facing the recessed portion 120. Therefore, the output voltage of the sine wave-shaped detection coil 32 and the cosine wave-shaped detection coil 33 varies according to the position of the rack shaft 12. In the graph shown in FIG. 6A, the peak voltage VS has a positive value when the induced voltage V1 induced in the sine wave-shaped detection coil 32 is in phase with the supply voltage V0 supplied to the exciting coil 31, and has a negative value when in antiphase. Likewise, in the graph shown in FIG. 6B, the peak voltage VC has a positive value when the induced voltage V2 induced in the cosine wave-shaped detection coil 33 is in phase with the supply voltage V0 supplied to the exciting coil 31, and has a negative value when in antiphase.

When the rack shaft 12 moves at a constant speed in one direction from one moving end to the other moving end, the peak voltage VS changes sinusoidally and the peak voltage VC changes cosinusoidally as shown in FIGS. 6A and 6B. Thus, the calculation unit 5 can determine the position of the rack shaft 12 by calculation based on the output voltages of the sine wave-shaped detection coil 32 and the cosine wave-shaped detection coil 33.

As shown in FIG. 3A, a position X of the rack shaft 12 can be obtained by the following equation (1), where the position of the left ends of the sine wave-shaped detection coil 32 and the cosine wave-shaped detection coil 33 in the longitudinal direction of the substrate 3 is a reference position O, the length of the sine wave-shaped detection coil 32 and the cosine wave-shaped detection coil 33 in the longitudinal direction of the substrate 3 is L, the position X of the rack shaft 12 when the center point 120c of the recessed portion 120 is aligned with the reference position O in the vertical direction of the substrate is 0 (zero) and the direction from the reference position O to the right end of the sine wave-shaped detection coil 32 and the cosine wave-shaped detection coil 33 is the positive side of the position X of the rack shaft 12, the position X of the rack shaft 12 can be obtained by the following formula (1).

$$\\ \begin{matrix}Formula ( 1 ) & \\ X = L \frac{{tan}^{- 1} ( \frac{Vs}{Vc} )}{2 π} & ( 1 )\end{matrix}$$

The calculation unit 5 outputs the position obtained by formula (1) based on the output voltages of the sine wave-shaped detection coil 32 and the cosine wave-shaped detection coil 33 to the steering controller 19 as the position of the rack shaft 12. When the ratio of the length of the recessed portion 120 in the axial direction of the rack shaft 12 to the length L of the sine wave-shaped detection coil 32 and the cosine wave-shaped detection coil 33 is u, the calculation unit 5 can obtain the absolute position of the rack shaft 12 within the length range of (1-u)L. The value of u is smaller than 0.5. The smaller the value of u, the more the absolute position of the rack shaft 12 can be detected over a longer distance, but if the value of u is too small, the induced voltages V1, V2 become smaller and the error is likely to increase. Therefore, the value of u is preferably 0.01 or more and 0.5 or less, for example.

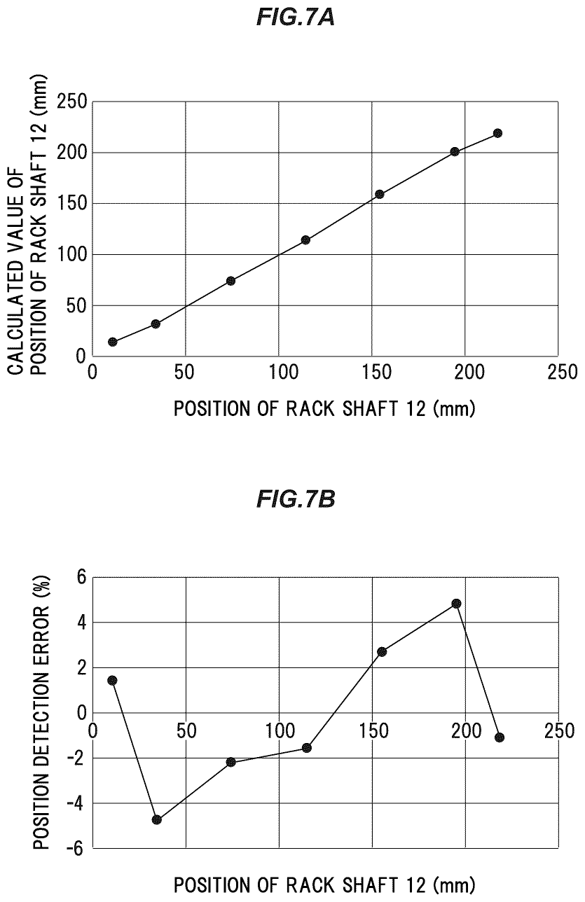

FIG. 7A is a graph showing the moving amount of the rack shaft 12 from the reference position on the horizontal axis and the position of the rack shaft 12 detected by the stroke sensor 2 on the vertical axis. The values on the vertical axis are the calculated values of the above formula (1) based on the induced voltages V1, V2 obtained using electromagnetic field simulation. FIG. 7B is a graph showing the moving amount of the rack shaft 12 from the reference position on the horizontal axis and the detection error rate in the moving amount of the rack shaft 12 on the vertical axis.

As shown in the graph in FIG. 7A, there is a generally linear relationship between the actual position of the rack shaft 12 and the position of the rack shaft 12 determined by stroke sensor 2, and the detection error is kept 5% or less as shown in FIG. 7B. This error is not caused accidentally by vibration or the like, for example, but occurs regularly as a detection characteristic, and can be corrected by performing a correction calculation.

(Comparison Example)

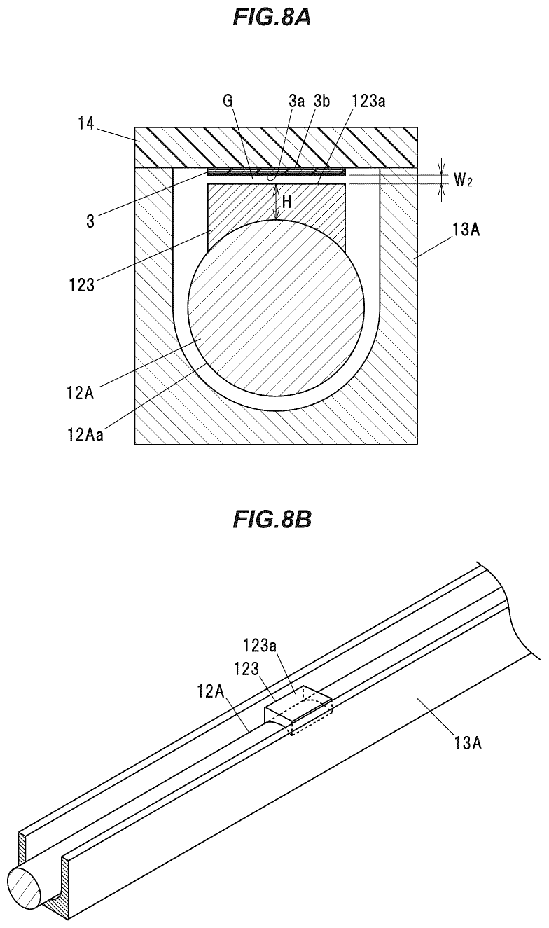

FIG. 8A is a cross-sectional view showing a configuration example when the stroke sensor 2 according to the embodiment detects the position of a rack shaft 12A in a comparative example, to which a conductive metal member as a detection target 123 is attached, relative to a housing 13A. FIG. 8B is a perspective view showing the rack shaft 12A, the detection target 123, and the housing 13A in the comparative example.

The rack shaft 12A is a machine structural carbon steel with a circular cross-section perpendicular to the axial direction, which is similar to the rack shaft 12 in the above embodiment, but without the recessed portion 120. The detection target 123 is made of a metal such as steel having an electrical conductivity equivalent to the rack shaft 12A or a good conductive metal such as a copper alloy or aluminum alloy having an electrical conductivity higher than the rack shaft 12A, and is attached to the rack shaft 12A so that it protrudes from an outer circumference surface 12Aa of the rack shaft 12A toward the substrate 3.

A protruding height H of the detection target 123 from the outer circumference surface 12Aa of the rack shaft 12A in the direction perpendicular to the substrate 3 is 5 mm, the same as a depth Dp of the recessed portion 120 of the rack shaft 12 in the above embodiment. A facing surface 123a of the detection target 123 with respect to the substrate 3 is parallel to the front surface 3a of the substrate 3, and the width W2 of the air gap G between the front surface 3a of the substrate 3 and the facing surface 123a of the detection target 123 is 1 mm or less, as is the width W1 of the air gap G in the above embodiment.

The housing 13A, like the housing 13 in the above embodiment, is made of aluminum alloy with a U-shaped cross-section and is open upward in the vertical direction. However, the outer dimension of the housing 13A in the direction perpendicular to the substrate 3 is larger than that of the housing 13 in the above embodiment, by the amount of the protruding height H of the detection target 123.

In this comparative example, the intensity of the magnetic field in the portion facing the detection target 123 in the sine wave-shaped detection coil 32 and the cosine wave-shaped detection coil 33 is stronger than the intensity of the magnetic field in the portion not facing the detection target 123. Due to this difference in magnetic field intensity, the output voltage of the sine wave-shaped detection coil 32 and the cosine wave-shaped detection coil 33 varies in accordance with the position of the rack shaft 12A.

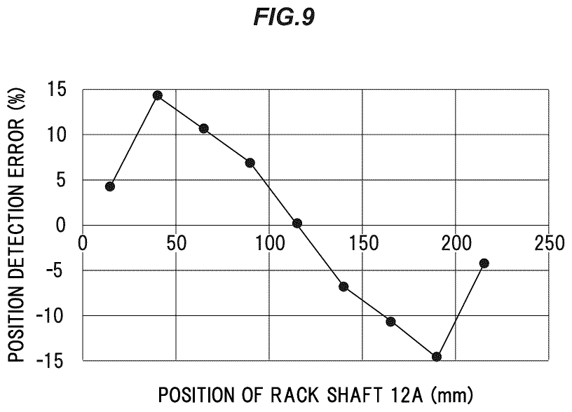

FIG. 9 is a graph showing the detection error of the moving amount of the rack shaft 12A in the comparative example. As shown in this graph, when the moving amount of the rack shaft 12A from the reference position is detected by the position of the detection target 123, the detection error is larger than in the above embodiment.

One possible cause of this increase in detection error is that the magnetic field generated by the exciting coil 31 also acts on the housing 13A at the side of the detection target 123. In other words, in the above embodiment, the distance between the rack shaft 12 made of conductive metal and the substrate 3 is close, so the magnetic field acting on the housing 13A is less likely to have an effect, but in the comparative example, the length of the detection target 123 in the axial direction of the rack shaft 12 is relatively short compared to the substrate 3. Therefore, it is considered that it is more affected by the magnetic field acting on the housing 13A than the above embodiment.

### Effects of the Embodiment

According to the embodiment described above, the position of the rack shaft 12 relative to the housing 13 can be detected by placing the substrate 3 to face the rack shaft 12 formed with the recessed portion 120, thus reducing the installation size of the stroke sensor 2. More specifically, since changes in the output voltage of the sine wave-shaped detection coil 32 and the cosine wave-shaped detection coil 33 due to the position of the rack shaft 12 are caused by the recessed portion 120, for example, as in the comparative example, mounting the detection target 123 on the rack shaft 12A does not increase the size of the housing 13A. In addition, the smaller installation size of the stroke sensor 2 makes it possible to reduce the size and weight of the vehicle steering device 1.

### SUMMARY OF THE EMBODIMENTS

Technical ideas understood from the embodiments will be described below citing the reference signs, etc., used for the embodiments. However, each reference sign, etc., described below is not intended to limit the constituent elements in the claims to the members, etc., specifically described in the embodiments.

According to the first feature, a position detecting device (stroke sensor) 2 configured to detect a position of a moving member (rack shaft) 12 in which a conductive portion 121 and a non-conductive portion (recessed portion) 120 having greater electrical resistance than the conductive portion 121 are provided side by side in a predetermined moving direction is provided with an exciting coil 31 and a detection coil 32, 33 that are arranged extending in the moving direction of the moving member 12, wherein a voltage is induced in the detection coil 32, 33 by a current flowing in the conductive portion 121 due to a magnetic field generated by the exciting coil 31, and wherein a magnitude of the voltage induced in the detection coil 32, 33 varies in accordance with a position in the moving direction of the moving member 12 relative to the detection coil 32, 33.

According to the second feature, in the position detection device 2 as described in the first feature, the detection coil 32, 33 comprises a plurality of detection coils 32, 33, and wherein a phase of the voltage induced in each of the plurality of detection coils 32, 33 during movement of the moving member 12 is different from each other.

According to the third feature, in the position detection device 2 as described in the second feature, a magnitude of the voltage induced in each of the plurality of detection coils 32, 33 varies within a range of one cycle or less while the moving member 12 moves from one moving end to the other moving end in an axial direction.

According to the fourth feature, in the position detection device 2 as described in the second or third features, each of the plurality of detection coils 32, 33 is a combination of two sinusoidal-shaped conductor wires (first to fourth curve portions) 301a, 302a, 303a, 304a, whose shape as viewed from a direction perpendicular to the moving direction is symmetrical across a symmetry axis line (center axis) C2 parallel to the moving direction.

According to the fifth feature, in the position detection device 2 as described in the first feature, the exciting coil 31 and the plurality of detection coils 32, 33 are formed on a single substrate 3, and the exciting coil 31 is formed on the substrate 3 to surround the plurality of detection coils 32, 33.

According to the sixth feature, in the position detection device 2 as described in the fifth feature, in the moving member 12, the conductive portion 121 has a circular cross-sectional shape, the non-conductive portion is a recessed portion 120 formed in a portion in a circumferential direction of an outer circumference surface 12a of the moving member 12, and the substrate 3 faces the recessed portion 120.

According to the seventh feature, a vehicle steering device 1 includes a shaft (rack shaft) 12 composed of a conductive metal that moves axially forward and backward along a vehicle width direction, a housing 13 composed of a conductive metal that houses the shaft 12, and a position detecting device (stroke sensor) 2 that detects a position of the shaft 12 relative to the housing 13, in which a wheel 10 is steered by axial movement of the shaft 12, the shaft 12 is provided with a recessed portion 120 formed in a radial direction, the position detection device 2 is provided with an exciting coil 31 and a detection coil 32, 33, arranged extending in the vehicle width direction on the shaft 12, wherein a voltage is induced in the detection coil 32, 33 by a current flowing in the shaft 12 due to a magnetic field generated by the exciting coil 31, and wherein a magnitude of the voltage induced in the detection coil 32, 33 varies in accordance with a position of the shaft 12 relative to the housing 13.

According to the eighth feature, in the vehicle steering device 1 as described in the seventh feature, the housing 13 has an opening 130 extending in the vehicle width direction, and further has a lid member 14 composed of a non-conductive material which closes the opening 130 of the housing 13, the exciting coil 31 and a plurality of detection coils 32, 33 are formed on a single substrate 3, and the substrate 3 is attached to the lid member 14.

The above description of the embodiment of the invention does not limit the invention as claimed above. It should also be noted that not all of the combinations of features described in the embodiment are essential for the invention to solve the problems of the invention.

The moving member to be detected in position by the stroke sensor 2 is not limited to the rack shaft 12 of the steering device 1, but may be an automotive or non-automotive shaft. The shape of the moving member is not limited to a shaft-like body, but can be of various shapes, such as a flat plate, for example.

1. A position detecting device configured to detect a position of a moving member in which a conductive portion and a non-conductive portion having greater electrical resistance than the conductive portion are provided side by side in a predetermined moving direction, comprising:
an exciting coil and a detection coil that are arranged extending in the moving direction of the moving member,
wherein a voltage is induced in the detection coil by a current flowing in the conductive portion due to a magnetic field generated by the exciting coil, and
wherein a magnitude of the voltage induced in the detection coil varies with a position in the moving direction of the moving member relative to the detection coil.

2. The position detection device, according to claim 1, wherein the detection coil comprises a plurality of detection coils, and wherein a phase of the voltage induced in each of the plurality of detection coils during movement of the moving member is different from each other.

3. The position detection device, according to claim 2, wherein a magnitude of the voltage induced in each of the plurality of detection coils varies within a range of one cycle or less while the moving member moves from one moving end to an other moving end in an axial direction.

4. The position detection device, according to claim 2, wherein each of the plurality of detection coils comprises a combination of two sinusoidal-shaped conductor wires, whose shape as viewed from a direction perpendicular to the moving direction is symmetrical across a symmetry axis line parallel to the moving direction.

5. The position detection device, according to claim 1, the exciting coil and the plurality of detection coils are formed on a single substrate, and the exciting coil is formed on the substrate to surround the plurality of detection coils.

6. The position detection device, according to claim 5, wherein, in the moving member, the conductive portion has a circular cross-sectional shape, the non-conductive portion is a recessed portion formed in a portion in a circumferential direction of an outer circumference surface of the moving member, and the substrate faces the recessed portion.

7. A vehicle steering device, comprising:
a shaft comprising a conductive metal that moves axially forward and backward along a vehicle width direction;
a housing comprising a conductive metal that houses the shaft; and
a position detecting device that detects a position of the shaft relative to the housing,
wherein a wheel is steered by axial movement of the shaft,
wherein the shaft is provided with a recessed portion formed in a radial direction,
wherein the position detection device comprises an exciting coil and a detection coil that are arranged extending in the vehicle width direction on the shaft,
wherein a voltage is induced in the detection coil by a current flowing in the shaft due to a magnetic field generated by the exciting coil, and
wherein a magnitude of the voltage induced in the detection coil varies in accordance with a position of the shaft relative to the housing.

8. The vehicle steering device, according to claim 7, wherein the housing comprises an opening extending in the vehicle width direction, and the vehicle steering device further comprises a lid member comprising a non-conductive material which closes the opening of the housing, the exciting coil and a plurality of detection coils are formed on a single substrate, and the substrate is attached to the lid member.
